(19) United States
(12) Patent Application Publication
(10) Pub. No.: US 2019/0043053 A1
(43) Pub. Date: Feb. 7, 2019

(54) METHOD AND SYSTEM FOR TRANSACTION AUTHORIZATION

(71) Applicant: MASTERCARD INTERNATIONAL INCORPORATED, Purchase, NY (US)

(72) Inventors: Navneet Jain, Pune (IN); Piyush Sharma, Pune (IN)

(21) Appl. No.: 16/036,317

(22) Filed: Jul. 16, 2018

(30) Foreign Application Priority Data
Aug. 1, 2017 (SG) 10201706266Y

(51) Int. Cl. G06Q 20/40; G06Q 20/34; G06Q 20/32; G06Q 20/10

(52) U.S. Cl. CPC G06Q 20/4014; G06Q 20/102; G06Q 20/322; G06Q 20/34

(57) ABSTRACT

A transaction authorization method and system for performing an authorization for a transaction are provided. The transaction authorization method includes receiving by a first server, a first request from a second server for initiating authorization for a transaction at a first time instance, when a user uses a first transaction card to initiate the transaction. A first set of parameters is associated with the first transaction card. The first server receives a second request for completing the authorization for the transaction at a second time instance, when the user uses a second transaction card to complete the transaction. A second set of parameters is associated with the second transaction card. The first server authorizes the transaction based on a match between the first set of parameters and the second set of parameters.

### CROSS REFERENCE TO RELATED APPLICATIONS

This patent application claims priority to Singapore Patent Application No. 10201706266Y filed on Aug. 1, 2017, the disclosure of which is incorporated by reference herein in its entirety as part of the present application.

### BACKGROUND

The present disclosure relates to a method and system for performing an authorization, and more particularly to a method and system for performing a pre-authorization for a transaction.

Evolution of several payment platforms has enabled users to conveniently perform various transactions, such as cash deposits and withdrawals, credit transfers, purchase payments, and the like. The payment platforms include automated teller machines (ATMs), point of sale (POS) devices, online payment gateways, and the like. The users transact by using transaction cards, such as debit cards, credit cards, or prepaid cards, to purchase various products and services. Typically, when a user performs a transaction by using a transaction card to purchase a product, the cost of the product is fixed and known to the user. However, when the user avails a service, such as renting a vehicle, reserving a hotel room, or the like, the cost associated with the service may vary based on duration of availing the service and nature of the service. Therefore, a merchant cannot possibly charge the user with the exact amount for availing the service. To solve this problem, the merchant may charge the user after he or she has availed the service. However, this may cause several problems for the merchant. For example, after availing the service, the user may decline to pay due to lack of funds. Hence, there is no guarantee to the merchant that the user will pay for the service availed.

A known solution to the abovementioned problem is to carry-out pre-authorization for a transaction. The user uses a transaction card at a payment platform, such as POS device or online payment gateway, to initiate a transaction for an estimated amount to avail a service. A payment network associated with the transaction card initiates a pre-authorization for the transaction and puts the estimated amount associated with the transaction under a temporary hold, when the user initiates the transaction. Hence, the user is no longer permitted to spend the amount under the temporary hold. As a follow up, the user completes the transaction by using the same transaction card at the same payment platform, when he or she has availed the service. The payment network then completes the pre-authorization and captures the transaction by charging the user with a final amount for the transaction. Therefore, the pre-authorization offers a guarantee to the merchant that the user will pay for the service, which he or she has availed. However, the user requires the same transaction card that was used to initiate the transaction, for completing the transaction. If the user loses the transaction card, the transaction cannot be completed, as the payment network is unable to complete the pre-authorization. The user may thus have to initiate a new transaction for the payment of the service, which causes inconvenience to both the merchant and the user. Further, the payment network has to process two transactions for authorization, i.e., the transaction that was not completed and the new transaction, for one service. Thus, the payment network incurs a transaction processing overhead.

In light of the foregoing, there exists a need for a technical solution that takes care of the completion of transactions and authorizations without causing any inconvenience to merchants, users, and payment networks, and does not incur any transaction processing overhead.

### BRIEF DESCRIPTION

An embodiment of the present disclosure provides a transaction authorization method. A user uses a first transaction card at a terminal device to initiate a transaction at a first time instance. A first server receives a first request from a second server for initiating authorization for the transaction. A first set of parameters is associated with the first transaction card. When the user uses a second transaction card at the terminal device to complete the transaction at a second time instance, the first server receives a second request for completing the authorization for the transaction. A second set of parameters is associated with the second transaction card. The first server authorizes the transaction based on a match between the first set of parameters and the second set of parameters.

Another embodiment of the present disclosure provides a transaction authorization system. The transaction authorization system includes a first server that includes a memory and a processor that communicates with the memory. The memory is configured to store information pertaining to a plurality of transactions. A user uses a first transaction card at a terminal device to initiate the transaction, at a first time instance. The processor receives a first request from a second server for initiating authorization for a transaction of the plurality of transactions. A first set of parameters is associated with the first transaction card. When the user uses a second transaction card at the terminal device to complete the transaction at a second time instance, the processor receives a second request for completing the authorization for the transaction. A second set of parameters is associated with the second transaction card. The processor authorizes the transaction based on a match between the first set of parameters and the second set of parameters.

Another embodiment of the present disclosure provides a transaction authorization system. The transaction authorization system includes a payment network server that includes a memory and an authorization management processor that communicates with the memory. The memory is configured to store information pertaining to a plurality of transactions. A user uses a first transaction card at a terminal device to initiate the transaction, at a first time instance. The authorization management processor receives a first request from a second server for initiating pre-authorization for a transaction of the plurality of transactions. A first set of parameters is associated with the first transaction card. When the user uses a second transaction card at the terminal device to complete the transaction at a second time instance, the authorization management processor receives a second request for completing the pre-authorization for the transaction. A second set of parameters is associated with the second transaction card. The processor authorizes the transaction based on a match between the first set of parameters and the second set of parameters.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates a communication environment for authorization of transactions, in accordance with an embodiment of the present disclosure;

FIG. 2 is a block diagram that illustrates a payment network server of the communication environment of FIG. 1, in accordance with an embodiment of the present disclosure;

FIG. 3 is a block diagram that illustrates an authorization management processor of the payment network server of FIG. 2, in accordance with an embodiment of the present disclosure;

FIGS. 4A-4D collectively represent a flow chart that illustrates a method for authorizing a transaction implemented using the communication environment of FIG. 1, in accordance with an embodiment of the present disclosure;

FIG. 5 represents a high-level flow chart that illustrates a method for authorizing a transaction implemented using the communication environment of FIG. 1, in accordance with an embodiment of the present disclosure; and

FIG. 6 is a block diagram that illustrates system architecture of a computer system, in accordance with an embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

Various embodiments of the present disclosure provide a method and system for performing authorization. A user initiates a transaction at a terminal device by using a first transaction card at a first time instance. A first set of parameters is associated with the first transaction card and includes at least one of a permanent account number, a name, and a date-of-birth of a cardholder of the first transaction card. A first server, for example a payment network server, receives a first request from a second server, for example an acquirer server, to initiate authorization for the transaction. The first request includes at least a type of authorization, a reference retrieval number (RRN), a terminal identification (TID) number, an amount associated with the transaction, a card number, and a card type associated with the first transaction card. For initiating the authorization, the first server flags-up the transaction based on the type of authorization, such as pre-authorization, associated with the transaction. The first server further retrieves and stores the first set of parameters associated with the first transaction card. Further, the user completes the transaction at the terminal device by using a second transaction card at a second time instance. A second set of parameters is associated with the second transaction card and includes at least one of a permanent account number, a name, and a date-of-birth of a cardholder of the second transaction card. The first server receives a second request from the second server to complete the authorization for the transaction. The second request includes at least the type of authorization, the RRN, the TID number, an amount associated with the transaction, a card number, and a card type associated with the second transaction card.

For completing the authorization, the first server compares the card number of the second request with the card number of the first request. In an event that the card number of the second request matches the card number of the first request, the first server authorizes the transaction and captures the transaction from an account associated with the first transaction card. In another event that the card number of the second request does not match the card number of the first request, the first server compares the second set of parameters with the first set of parameters. The first server authorizes the transaction and captures the transaction from an account associated with the second transaction card based on a match between the first and second sets of parameters. However, the first server rejects the transaction in an event that the second set of parameters does not match the first set of parameters. The first server further transmits an authorization response message to the terminal device. Hence, the first server makes it convenient for the user, as he or she is able to initiate and complete transactions by using different transaction cards.

### Terms Description (In Addition to Plain and Dictionary Meaning)

Authorization includes a method of verifying a transaction initiated by use of a transaction card. Thus, authorizing a transaction may include verification that whether the transaction card used for the transaction is eligible for performing the transaction or not. For example, a user may use a debit card to perform a transaction, such that the transaction amount exceeds an available balance of the account linked to the debit card. Therefore, a banking authority responsible for authorizing transactions may determine that the transaction is not authorized. A type of authorization is pre-authorization.

Pre-authorization, preauth, or authorization hold is a type of authorization. When pre-authorization is initiated for a transaction by using a transaction card, a transaction amount associated with the transaction is held unavailable for use from an account or credit line balance associated with the transaction card. The transaction amount is actually deducted from the account or credit line balance only when the pre-authorization is completed by using the transaction card. The hold on the transaction amount may fall off in an event the pre-authorization is not completed depending on one or more banking policies. In such a case, the transaction amount is rendered available for use again. However, the transaction amount may be charged back within a pre-determined time-period, such as 30 days, if the transaction remains unsettled, i.e., if the transaction is not captured. Therefore, pre-authorization is a two-step authorization. Pre-authorization is generally performed for an estimated transaction amount or a final transaction amount and the transaction associated with pre-authorization may be eligible for cancelation.

First and second transaction cards are suitable payment devices, such as debit cards, credit cards, prepaid cards, gift cards, promotional cards, contactless cards, and/or other devices that may hold identification information of an account. The first and second transaction cards can be used to perform transactions, such as deposits and withdrawals, credit transfers, purchase payments, and the like. In an embodiment, the first and second transaction cards may be radio frequency identification (RFID) or near field communication (NFC) enabled for performing contactless payments.

First and second sets of parameters are address verification parameters associated with first and second transaction cards, respectively. The first set of parameters includes a name, a date-of-birth, a permanent account number, a registered contact number, and an address of a cardholder of the first transaction card. The second set of parameters includes a name, a date-of-birth, a permanent account number, a registered contact number, and an address of a cardholder of the second transaction card.

Terminal device is a point-of-sale (POS) device, point-of-interaction (POI) device, point-of-purchase (POP) device, or near field communication (NFC) POS device installed within retail establishments, such as merchant stores, for initiating transactions by use of transaction cards, for example the first and second transaction cards. In one embodiment, the terminal device includes a card reader to read account identification information stored in a transaction card for communicating it to a merchant server. In an example, a user may insert, swipe, or tap a debit card at the terminal device to initiate a transaction. The card reader in the terminal device reads the account identification information stored in the debit card. In another embodiment, the terminal device includes an input mechanism that enables the user to enter the account identification information for initiating the transaction. In yet another embodiment, the terminal device is enabled to receive transaction card information that is electronically stored in a user device, such as a mobile phone.

Merchant is an entity that offers various products and/or services in exchange of payments. The merchant may establish a merchant account with a financial institution, such as a bank (hereinafter “acquirer bank”) to accept the payments from several users by use of one or more payment methods.

Issuer or issuer bank is a financial institution, such as a bank, where accounts of several users are established and maintained. The issuer bank ensures payment for authorized transactions in accordance with various payment network regulations and local legislation.

Payment network is a transaction card association that acts as an intermediate entity between acquirer banks and issuer banks to authorize and fund transactions. Examples of payment networks include MasterCard®, American Express®, VISA®, Discover®, Diners Club®, and the like. The payment network settles the transactions between various acquirer banks and issuer banks when transaction cards are used for initiating transactions. The payment network authorizes a transaction card used by a user for initiating a transaction. If a user uses a stolen debit card for initiating a transaction, the payment network may not authorize the transaction card and thus may not authorize the transaction. The payment networks authorize the transactions based on one or more banking policies associated with type of authorization of each transaction.

First server is a physical or cloud data processing system on which a server program runs. The first server may be implemented in hardware or software, or a combination thereof. In one embodiment, the first server may be implemented in computer programs executing on programmable computers, such as personal computers, laptops, or a network of computer systems. The first server may correspond to a payment network server.

Second server is a physical or cloud data processing system on which a server program runs. The second server may be implemented in hardware or software, or a combination thereof. In one embodiment, the second server may be implemented in computer programs executing on programmable computers, such as personal computers, laptops, or a network of computer systems. The second server may correspond to an acquirer server.

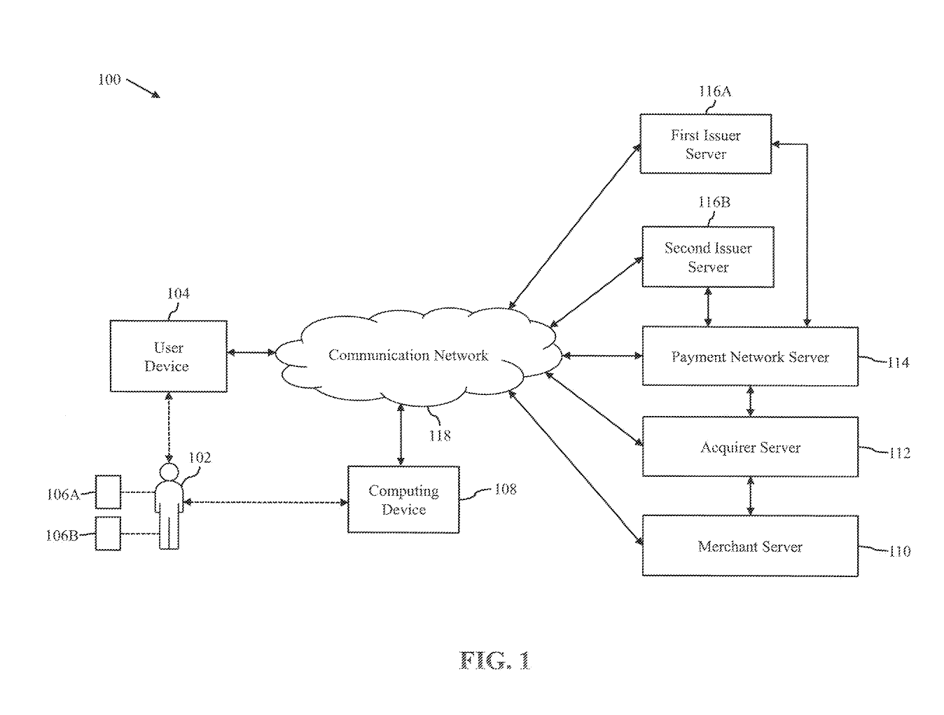

Referring now to FIG. 1, a block diagram that illustrates a communication environment 100 for authorization of transactions, in accordance with an embodiment of the present disclosure is shown. The communication environment 100 includes a user 102 in possession of a user device 104, and first and second transaction cards 106A and 106B. The communication environment 100 further includes a terminal device 108, a merchant server 110, an acquirer server 112, a payment network server 114, and first and second issuer servers 116A and 116B. The user device 104 and the terminal device 108 communicate with the merchant server 110, the acquirer server 112, the payment network server 114, and the first and second issuer servers 116A and 116B by way of a communication network 118.

The user 102 is an individual who performs a transaction from an account. Examples of the transaction include a product or service purchase, a credit purchase, a debit transaction, a fund transfer, an online purchase, a withdrawal, and the like. The user 102 may use the first or second transaction card 106A or 106B for performing the transaction. Each of the first and second transaction cards 106A and 106B refers to any suitable payment card, such as a credit card, a debit card, a membership card, a promotional card, a charge card, a prepaid card, or a gift card. In various embodiments, the first and second transaction cards 106A and 106B are physical cards or virtual cards that are electronically stored in a memory (not shown) of the user device 104. The first and second transaction cards 106A and 106B may be linked to single or multiple accounts of the user 102. For example, the first and second transaction cards 106A and 106B may be linked to a first account of the user 102, or the first transaction card 106A may be linked to the first account and the second transaction card 106B may be linked to a second account of the user 102.

The first and second transaction cards 106A and 106B each include identification information that corresponds to an account to which they are linked. The identification information may include an account number, a unique card number, an expiry date, a card security code, a card type, address verification parameters of the user 102, and the like. Further, the address verification parameters may include a name, a date-of-birth, a permanent account number, a registered contact number, and an address of the user 102. One or more financial institutions, such as issuer banks that maintain accounts corresponding to the first and second transaction cards 106A and 106B, issue the first and second transaction cards 106A and 106B to the user 102. Thus, the user 102 corresponds to a cardholder of the first and second transaction cards 106A and 106B.

The user device 104 is a communication device of the user 102. A unique identification number, such as the registered contact number of the user 102, may be associated with the user device 104. The user 102 may register the contact number with an issuer bank, at the time he or she sets up an account with the issuer bank. Examples of the user device 104 include, but are not limited to, a mobile phone, a smartphone, a personal digital assistant (PDA), a tablet, a phablet, or any other portable communication device.

The terminal device 108 is an electronic device using which the user 102 performs a transaction. The user 102 may use the first or second transaction card 106A or 106B to perform the transaction. In an embodiment, the terminal device 108 reads the identification information of the first or second transaction card 106A or 106B. In another embodiment, the terminal device 108 receives the identification information when the user 102 enters the details of the first or second transaction card 106A or 106B in the terminal device 108. In yet another embodiment, the terminal device 108 receives the identification information that is stored electronically in the user device 104. Examples of the terminal device 108 include, but are not limited to, an automated teller machine (ATM) linked with a financial institution, such as a bank, or a POS device, a POP device, a POI device, or an NFC POS device installed at a retail establishment, i.e., at a merchant store. The terminal device 108 may also be a smart phone, a PDA, a tablet, a phablet, a personal computer, a laptop, or any other portable device that hosts an online payment gateway using which the user 102 initiates an e-commerce transaction.

The terminal device 108 transmits details of the transaction (hereinafter “transaction details”) to at least one of the merchant server 110, the acquirer server 112, the payment network server 114, or the first and second issuer servers 116A and 116B, over the communication network 118. The transaction details include the identification information of an account, a transaction amount, a time and a date of the transaction, a type of authorization, such as pre-authorization, for the transaction, a reference retrieval number (RRN) of the transaction, a terminal identification (TID) number of the terminal device 108, a unique card number, a card type, and the like. The transaction details may further include additional information and/or data fields that are pursuant to one or more standards for the interchange of transaction messages, such as the ISO 8583 standard. The user 102 or the merchant may select the type of authorization for the transaction by using the terminal device 108. Alternatively, the type of authorization may be based on a type of product or service the user 102 wants to purchase. For example, pre-authorization is set as default authorization for transactions related to rental vehicles, hotel reservations, purchase of products and services online, and the like. The RRN of the transaction is used to retrieve any information, such as transaction history, associated with the transaction. The TID number is a unique identification number associated with the terminal device 108 that is used to identify the merchant associated with the terminal device 108. The unique card number is a transaction card identification number and is different for all transaction cards. For example, the unique card number for the first transaction card 106A may correspond to a 16-digit number that uniquely identifies the first transaction card 106A. The card is a brand of payment network associated with a transaction card, i.e., the first and second transaction cards 106A and 106B. For example, the first transaction card 106A may be associated with MasterCard®, hence the card type of the first transaction card 106A is MasterCard.

The merchant server 110 is a computing server that is associated with a merchant (not shown). The merchant may establish a merchant account with an acquirer bank to accept the payments. In an embodiment, the merchant server 110 is communicatively linked to the terminal device 108 installed at the merchant store via the communication network 118. Therefore, the merchant server 110 processes all the transactions initiated at the terminal device 108. In another embodiment, the merchant server 110 is communicatively linked to an online payment gateway used by the user 102 for e-commerce transactions via the communication network 118. The merchant server 110 communicates the transaction details of several transactions performed at the terminal device 108 to the acquirer server 112 or the payment network server 114, through the communication network 118.

The acquirer server 112 is a computing server that is associated with the acquirer bank. The acquirer bank processes the transaction details of several transactions received from the terminal device 108 or the merchant server 110 by using the acquirer server 112. The acquirer server 112 transmits the transaction details to the payment network server 114, or the first or second issuer server 116A or 116B, via the communication network 118. In an embodiment, the acquirer server 112 credits or debits the merchant account in the acquirer bank with the transaction amount when the transaction is captured at an issuer server, i.e., the first or second issuer server 116A or 116B.

The payment network server 114 is a computing server that is associated with a payment network of a transaction card, i.e., the first or second transaction cards 106A and 106B. The payment network server 114 represents an intermediate entity between the acquirer server 112, and the first and second issuer servers 116A and 116B for authorizing and funding the transactions initiated by use of transaction cards, such as the first and second transaction cards 106A and 106B. The payment network server 114 processes transactions for authorization. For authorizing a transaction, the payment network server 114 performs one or more operations specific to the type of authorization, such as pre-authorization, associated with the transaction. Further, the payment network server 114 communicates the outcome of the authorization to the first and second issuer servers 116A and 116B, over the communication network 118, for further processing of the transaction.

The first issuer server 116A is a computing server that is associated with a first issuer bank. The first issuer bank is a financial institute that manages accounts of multiple users. Account details of the accounts established with the first issuer bank are stored as account profiles in a memory (not shown) of the first issuer server 116A or a cloud server associated with the first issuer server 116A. The account details may include an account balance, a credit line, details of an account holder, transaction history of the account holder, account identification information, and the like. The details of the account holder may include name, age, gender, physical attributes, registered contact number, alternate contact number, email ID, and the like of the account holder. The first issuer server 116A receives transaction details of various transactions from one or more entities, such as the terminal device 108, the merchant server 110, the acquirer server 112, or the payment network server 114, over the communication network 118. The first issuer server 116A performs user authentication for various transactions and determines whether a user initiating the transaction from an account, is a legitimate account holder. The first issuer server 116A then processes the transactions for approval or rejection based on the authorization and the user authentication.

Similarly, the second issuer server 116B is a computing server that is associated with a second issuer bank. It will be understood by a person skilled in the art that the second issuer server 116B performs similar functions as performed by the first issuer server 116A. Methods for processing the transactions via the first and second issuer servers 116A and 116B will be apparent to persons having skill in the art and may include processing a transaction via the traditional four-party system or the traditional three-party system.

Examples of the merchant server 110, the acquirer server 112, the payment network server 114, and the first and second issuer servers 116A and 116B include, but are not limited to, a computer, a laptop, a mini computer, a mainframe computer, any non-transient and tangible machine that can execute a machine-readable code, a cloud-based server, or a network of computer systems.

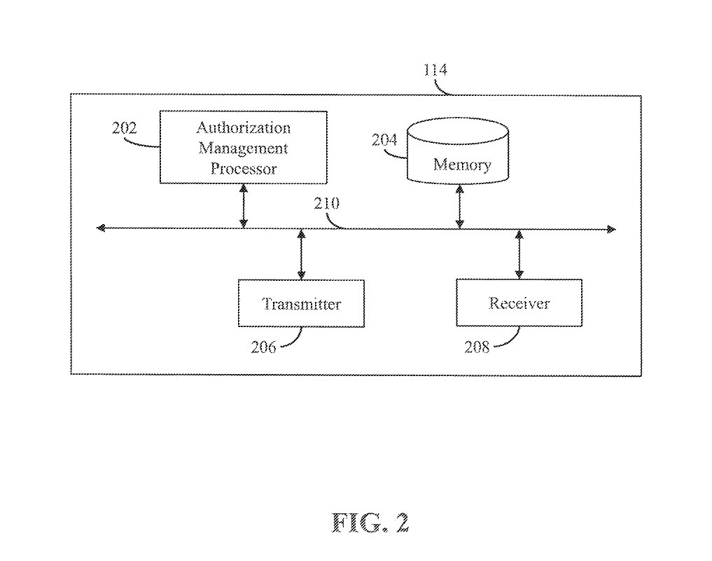

The communication network 118 is a medium through which content and messages are transmitted between various devices, such as the user device 104, the terminal device 108, the merchant server 110, the acquirer server 112, the payment network server 114, and the first and second issuer servers 116A and 116B. Examples of the communication network 118 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various devices in the communication environment 100 may connect to the communication network 118 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G) communication protocols, Long Term Evolution (LTE) communication protocols, or any combination thereof. The functioning of the payment network server 114 is explained in conjunction with FIG. 2.

Referring now to FIG. 2, a block diagram that illustrates the payment network server 114 of the communication environment 100 of FIG. 1, in accordance with an embodiment of the present disclosure is shown. The payment network server 114 includes an authorization management processor 202, a memory 204, a transmitter 206, and a receiver 208, that communicate with each other via a bus 210.

The authorization management processor 202 executes instructions stored in the memory 204 and performs authorization for various transactions based on at least the type of authorization, such as pre-authorization, associated with each transaction. For authorizing a transaction, the authorization management processor 202 determines the type of authorization, such as pre-authorization, associated with the transaction. Further, the authorization management processor 202 flags-up the transaction based on the type of authorization and performs one or more operations specific to the type of authorization associated with the transaction. For example, the authorization management processor 202 flags-up the transaction for pre-authorization. The authorization management processor 202 communicates results of authorizations to one or more entities, such as the terminal device 108, the merchant server 110, the acquirer server 112, and the first or second issuer server 116A or 116B. Examples of the authorization management processor 202 include a central processing unit (CPU), a general purpose processor (GPP), an application-specific integrated circuit (ASIC) processor, a reduced instruction set computing (RISC) processor, a complex instruction set computing (CISC) processor, and the like.

The memory 204 includes suitable logic, circuitry, and/or interfaces to store details of the transactions received from one or more entities, such as the terminal device 108, the merchant server 110, and the acquirer server 112. The memory 204 also stores details of various issuer banks and various acquirer banks, which are participating members of the payment network. Examples of the memory 204 include a random-access memory (RAM), a read-only memory (ROM), a removable storage drive, a hard disk drive (HDD), a flash memory, a solid-state memory, and the like. It will be apparent to a person skilled in the art that the scope of the disclosure is not limited to realizing the memory 204 in the payment network server 114, as described herein. In another embodiment, the memory 204 may be realized in form of a database server or a cloud storage working in conjunction with the payment network server 114, without departing from the scope of the disclosure.

The transmitter 206 transmits data over the communication network 118 by using one or more communication network protocols. The transmitter 206 transmits responses to various requests for authorization to one or more entities, such as the terminal device 108, the merchant server 110, the acquirer server 112, or the first and second issuer servers 116A and 116B. In one example, the transmitter 206 transmits an outcome of authorization for a transaction to the first issuer server 116A for further processing of the transaction. The outcome of the authorization confirms whether the transaction is authorized or not authorized. Examples of the transmitter 206 include an antenna, a radio frequency transmitter, a wireless transmitter, and the like.

The receiver 208 receives data over the communication network 118 by using one or more communication network protocols. The receiver 208 receives requests for authorization of several transactions from the terminal device 108, the merchant server 110, the acquirer server 112, and other entities that are pursuant to one or more standards for the interchange of transaction messages, such as the ISO 8583 standard. The receiver 208 receives a set of parameters associated with a transaction card used to perform the transaction as well as any additional data suitable for performing the functions disclosed herein, such as data that may be used in the authorization of the transaction. Examples of the receiver 208 include an antenna, a radio frequency receiver, a wireless receiver, and the like. It will be apparent to a person skilled in the art that the scope of the disclosure is not limited to realizing the transmitter 206 and the receiver 208 as separate components, as shown. In another embodiment, the functionalities of the transmitter 206 and the receiver 208 may be performed by a single component, such as a transceiver (not shown), without departing from the scope of the disclosure.

In operation, the user 102 initiates a transaction at the terminal device 108 by using the first transaction card 106A at a first time instance. For example, the user 102 may check-in at a hotel and initiate a transaction at the terminal device 108 for an estimated amount. The first issuer bank may have issued the first transaction card 106A to the user 102 and the first transaction card 106A is linked to a first account maintained with the first issuer bank.

The terminal device 108 transmits the transaction details to one of the merchant server 110, the acquirer server 112, or the payment network server 114, via the communication network 118. The transaction details include the identification information of the first account, the estimated transaction amount, time and date of the transaction, a type of authorization, i.e., pre-authorization, for the transaction, an RRN of the transaction, a TID number of the terminal device 108, a unique card number, a card type of the first transaction card 106A, and the like. In one example, the terminal device 108 transmits the transaction details to the merchant server 110 and the merchant server 110 further transmits the transaction details to the acquirer server 112, via the communication network 118. In another example, the terminal device 108 transmits the transaction details directly to the acquirer server 112, via the communication network 118. The acquirer server 112 transmits a first request to the payment network server 114 for initiating an authorization for the transaction. The first request includes the transaction details of the transaction.

The authorization management processor 202 receives the first request from one of the terminal device 108, the merchant server 110, and the acquirer server 112, via the communication network 118. The authorization management processor 202 determines the type of authorization associated with the transaction based on the first request. In an example, the merchant may select the type of authorization for the transaction as pre-authorization, which is communicated to the authorization management processor 202 through the first request. Thus, the authorization management processor 202 initiates pre-authorization for the transaction.

In an embodiment, the authorization management processor 202 may transmit a message to the first issuer server 116A to determine whether the first issuer bank is participating in the authorization. Thus, in response to the message, the first issuer server 116A communicates a participation status to the authorization management processor 202. In another embodiment, the authorization management processor 202 may determine whether the first issuer bank is participating in the authorization for the transaction based on the details of the first issuer bank stored in the memory 204. For example, the first issuer bank and the payment network may have an issuer-network partnership for processing transactions.

In an event that the authorization management processor 202 determines that the first issuer bank is not participating in the authorization for the transaction, the authorization management processor 202 may not authorize the transaction. The authorization management processor 202 transmits a notification to the terminal device 108, the merchant server 110, and/or the acquirer server 112 for communicating a status of the authorization as “not authorized”. In another event that the authorization management processor 202 determines that the first issuer bank is participating in the authorization, i.e., the pre-authorization, the authorization management processor 202 sets a status of pre-authorization flag to “1” for the transaction. Further, the authorization management processor 202 activates the transaction. Activation of the transaction includes capturing the card number of the first transaction card 106A and the RRN of the transaction from the first request and storing in the memory 204. In one example, the RRN of the transaction is a data element 37 pursuant to the ISO 8583 standard. The authorization management processor 202 further stores the first request in the memory 204. The authorization management processor 202 may use the RRN of the transaction to retrieve data associated with the transaction from the memory 204. The authorization management processor 202 further retrieves a first set of parameters, i.e., address verification parameters, associated with the first transaction card 106A. In an embodiment, the authorization management processor 202 retrieves the first set of parameters from the memory 204. In another embodiment, the authorization management processor 202 transmits a query to the first issuer server 116A to retrieve the first set of parameters associated with the first transaction card 106A. In yet another embodiment, the authorization management processor 202 may retrieve the first set of parameters from cloud storage or a database server associated with the first issuer server 116A that stores account details of all accounts maintained in the first issuer bank. The authorization management processor 202 stores the first set of parameters in the memory 204 and may further link the first set of parameters with the RRN of the transaction.

The authorization management processor 202 communicates with the first issuer server 116A to reserve the estimated transaction amount from an “open-to-buy” account balance or credit line of the first account, via the communication network 118. Thus, the authorization management processor 202 makes the estimated transaction amount unavailable for use by the user 102, until the user 102 completes or settles the transaction. In an embodiment, the first issuer server 116A may perform user authentication for the transaction to confirm an identity of the user 102. It will be apparent to a person skilled in the art that the first issuer server 116A may use any authentication technique known in the art for performing user authentication.

The user 102 may attempt to complete the transaction by using the first transaction card 106A or second transaction card 106B at the terminal device 108 at a second time instance. In one scenario, the user 102 may use the first transaction card 106A at the terminal device 108 in the hotel at the time of check-out for completing the transaction. In another scenario, the user 102 may misplace the first transaction card 106A and therefore may use the second transaction card 106B at the terminal device 108 in the hotel at the time of check-out for completing the transaction. In one embodiment, the terminal device 108 transmits the transaction details to the merchant server 110 and the merchant server 110 further transmits the transaction details to the acquirer server 112. In another embodiment, the terminal device 108 transmits the transaction details directly to the acquirer server 112. The acquirer server 112 further transmits a second request, which includes transaction details, to the payment network server 114 for completing the transaction. The second request includes the transaction details which include the identification information of an account linked to the first or second transaction card 106A or 106B, the final transaction amount, a time and a date of the transaction, a type of authorization for the transaction, an RRN of the transaction, a TID number of the terminal device 108, a unique card number of the first or second transaction card 106A or 106B, a card type of the first or second transaction card 106A or 106B, and the like. The RRN of the transaction in the second request is linked to the RRN of the transaction in the first request. For example, the RRN of the transaction in the second request may be same as that of the RRN of the transaction in the first request.

The authorization management processor 202 receives the second request from one of the terminal device 108, the merchant server 110, and the acquirer server 112. The authorization management processor 202 determines the type of authorization associated with the transaction. For example, the merchant may select the type of authorization for the transaction as pre-authorization. Thus, the authorization management processor 202 retrieves the RRN of the transaction from the second request. Based on the RRN of the transaction, the authorization management processor 202 identifies the status of the pre-authorization flag, i.e., “1”, associated with the transaction that was initiated previously.

The authorization management processor 202 attempts to complete the authorization, i.e., pre-authorization, based on the pre-authorization flag. For completing the pre-authorization, the authorization management processor 202 determines whether the user 102 has used the same card to complete the transaction that was used to initiate the transaction by comparing the card number associated with the first request with the card number associated with the second request. For example, when the user 102 uses the first transaction card 106A to complete the transaction, the authorization management processor 202 determines that the card number associated with the second request matches the card number associated with the first request. Thereafter, the authorization management processor 202 completes the authorization, i.e., pre-authorization, and authorizes the transaction for further processing.

Similarly, when the user 102 uses the second transaction card 106B to complete the transaction, the authorization management processor 202 determines that the card number associated with the second request does not match the card number associated with the first request. The authorization management processor 202 further determines whether the second issuer bank associated with the second transaction card 106B is participating in the authorization, i.e., the pre-authorization. In an embodiment, the authorization management processor 202 may not complete the authorization if the second issuer bank is not participating in the authorization. In another embodiment, the authorization management processor 202 may transmit a request to the second issuer server 116B to participate in the authorization, i.e., the pre-authorization. Based on the participation of the second issuer bank in the authorization, the authorization management processor 202 retrieves and compares the TID number and card type in the first request with the TID number and the card type in the second request, respectively. The authorization management processor 202 compares the TID number in the first request with the TID number in the second request to ensure that the user 102 has attempted to complete the transaction at the same terminal device, i.e., the terminal device 108, at which the user 102 had initiated the transaction previously. Further, the authorization management processor 202 compares the card type in the first request with the card type in the second request to ensure that a payment network associated with the second transaction card 106B is same as the payment network associated with the first transaction card 106A.

The authorization management processor 202 does not complete the pre-authorization, if the TID number or the card type in the second request does not match the TID number or the card type in the first request, respectively. In an example, the TID number and the card type in the first request are “98659067” and “MasterCard”, respectively. The TID number and the card type in the second request are “98659543” and “MasterCard”, respectively. In this scenario, the authorization management processor 202 determines that the card types in the first and second requests in the first and second requests match. However, the TID numbers in the first and second requests do not match. Therefore, authorization management processor 202 does not complete the pre-authorization and communicates the status of the authorization as “not authorized” to the terminal device 108. In an embodiment, the authorization management processor 202 may reject the transaction if the pre-authorization is not completed.

In another example, the TID number and the card type in the first request are “98659067” and “MasterCard”, respectively. The TID number and the card type in the second request are “98659067” and “MasterCard”, respectively. In this scenario, the authorization management processor 202 determines that the TID number and the card type in the first and second requests match and transmits a query to the second issuer server 116B to retrieve a second set of parameters associated with the second transaction card 106B. For example, the second set of parameters corresponds to address verification parameters associated with the second transaction card 106B. The second set of parameters may include a permanent account number, a name, or a date-of-birth, a registered contact number, and an address, and the like, of the cardholder, i.e., the user 102, of the second transaction card 106B. The authorization management processor 202 retrieves the first set of parameters from the memory 204 by using the RRN of the transaction and compares it with the second set of parameters.

In an embodiment, the authorization management processor 202 does not complete the authorization, i.e., the pre-authorization, when there is a mismatch between the first set of parameters and the second set of parameters. For example, the first set of parameters of the first request include “ABCDE7883F”, “Jan. 4, 1980”, and “John Smith” and the second set of parameters of the second request include “ABCDE6457G”, “May 6, 1991”, and “Gary Jones”. In this scenario, the authorization management processor 202 determines that the first and second set of parameters do not match and hence does not complete pre-authorization. The authorization management processor 202 transmits the authorization response message to the terminal device 108, the merchant server 110, and/or the acquirer server 112 for communicating the status of the authorization as “not authorized”. Further, the authorization management processor 202 transmits a message to the terminal device 108 for instructing the user 102 to use the first transaction card 106A to complete the transaction.

In another embodiment, the authorization management processor 202 completes the authorization, i.e., the pre-authorization, and authorizes the transaction for further processing when the first and second set of parameters match. For example, when the first set of parameters of the first request include “ABCDE7883F”, “Jan. 4, 1980”, and “John Smith” and the second set of parameters of the second request include “ABCDE7883F”, “Jan. 4, 1980”, and “John Smith”, the authorization management processor 202 determines that first and second sets of parameters match and hence completes the pre-authorization. The authorization management processor 202 transmits the authorization response message to the terminal device 108, the merchant server 110, and/or the acquirer server 112 for communicating the status of the authorization as “authorized”. In an embodiment, the authorization management processor 202 transmits the result of authorization to the second issuer server 116B associated with the second transaction card to settle the transaction from a second account associated with the second transaction card 106B. The authorization management processor 202 transmits a message to the first issuer server 116A to release the estimated transaction amount that was on hold from the first account. In another embodiment, the authorization management processor 202 transmits the result of authorization to the first issuer server 116A to settle the transaction from the first account by using the final transaction amount. It will be apparent to a person skilled in the art that the first or second issuer server 116A or 116B settles the transaction in accordance with various payment network regulations and local legislation.

Thus, the communication environment 100 provides a convenient means to users and merchants to perform transactions. The communication environment 100 allows completion of authorization, i.e., the pre-authorization, for a transaction by using a different transaction card from the one based on which the authorization, i.e., the pre-authorization, was initiated. Hence, the communication environment 100 eliminates the dependency of performing authorization for a transaction on one transaction card. In addition, this is convenient for the user 102 as he or she is allowed to initiate and complete a transaction by using two different transaction cards that have same address verification parameters. In conventional transaction systems, if the user 102 loses the first transaction card 106A used for initiating the transaction, he or she has to perform a new transaction by using a different transaction card, as there was no provision to complete the initiated transaction by using any other transaction card. Hence, the conventional transaction systems have to process two transactions, i.e., the initiated and the new transaction, for one service. However, the communication environment 100 permits the user 102 to use the second transaction card 106B to complete the transaction without having to initiate a new transaction. Hence, the payment network server 114 processes only one transaction for one service. Therefore, the communication environment 100 reduces the transaction processing overhead on the payment network server 114 in comparison with conventional transaction systems. Hence, transaction-handling capacity of the communication environment 100 is improved in comparison to the conventional transaction systems.

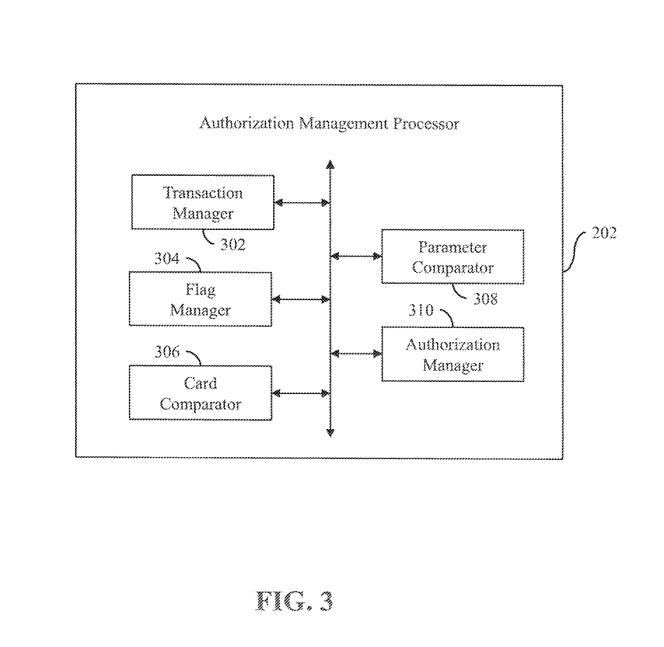

Referring now to FIG. 3, a block diagram that illustrates the authorization management processor 202 of the payment network server 114 of FIG. 2, in accordance with an embodiment of the present disclosure is shown. The authorization management processor 202 includes a transaction manager 302, a flag manager 304, a card comparator 306, a parameter comparator 308, and an authorization manager 310.

The transaction manager 302 includes suitable logic, circuitry, and/or interfaces to process one or more requests, such as the first and second requests, for authorizing transactions. The transaction manager 302 further determines a participation of an issuer bank, for example the first or second issuer bank, for authorizing the transactions. The transaction manager 302 activates or deactivates the transactions. In one embodiment, the transaction manager 302 retrieves data associated with the transactions from the memory 204 by using the RRN of each of the transactions.

The flag manager 304 includes suitable logic, circuitry, and/or interfaces to set or reset a status of pre-authorization flag for each of the transactions. For example, the flag manager 304 sets a status of the pre-authorization flag to “1”, when the pre-authorization is initiated for the transaction. The flag manager 304 resets a status of the pre-authorization flag to “0”, when the pre-authorization is completed for the transaction.

The card comparator 306 includes suitable logic, circuitry, and/or interfaces to compare card numbers of transaction cards that are used to initiate and complete authorization for a transaction. For example, the card comparator 306 compares the card number of the first transaction card 106A associated with the first request with the card number of the second transaction card 106B associated with the second request. Based on the comparison, the card comparator 306 determines whether the user 102 has used the same card to complete the transaction that was used to initiate the transaction.

The parameter comparator 308 includes suitable logic, circuitry, and/or interfaces to compare set of parameters associated with transaction cards that are used to initiate and complete authorization for a transaction. For example, the parameter comparator 308 compares the first set of parameters of the first transaction card 106A with the second set of parameters of the second transaction card 106B.

The authorization manager 310 includes suitable logic, circuitry, and/or interfaces to authorize transactions based on a completion of the pre-authorization. In one example, the authorization manager 310 authorizes a transaction by completing the pre-authorization when the card number associated with the second request matches the card number associated with the first request. In another example, the authorization manager 310 authorizes a transaction by completing the pre-authorization when the first set of parameters associated with the first transaction card 106A matches the second set of parameters associated with the second transaction card 106B. In yet another example, the authorization manager 310 may not authorize a transaction when the pre-authorization is not completed.

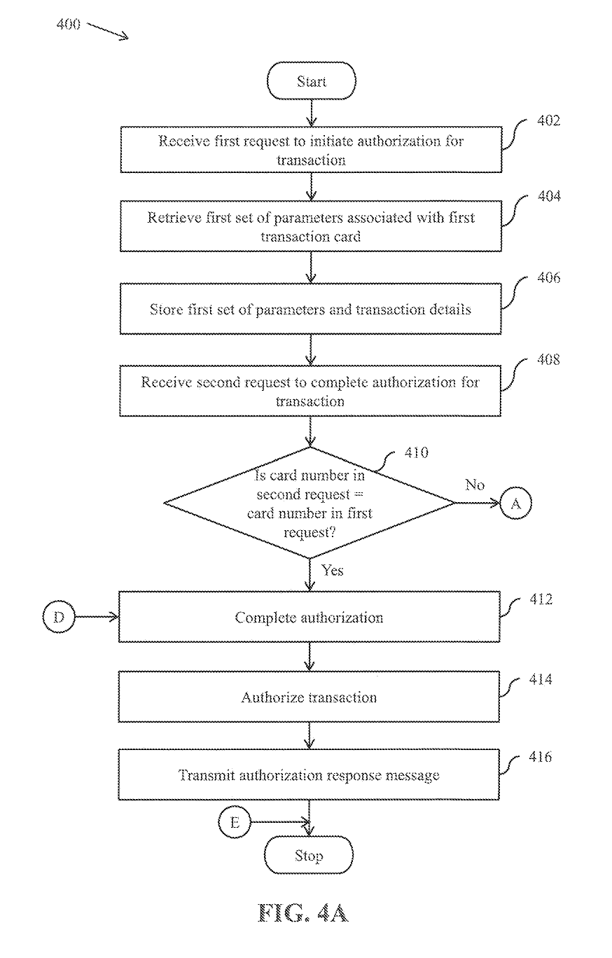

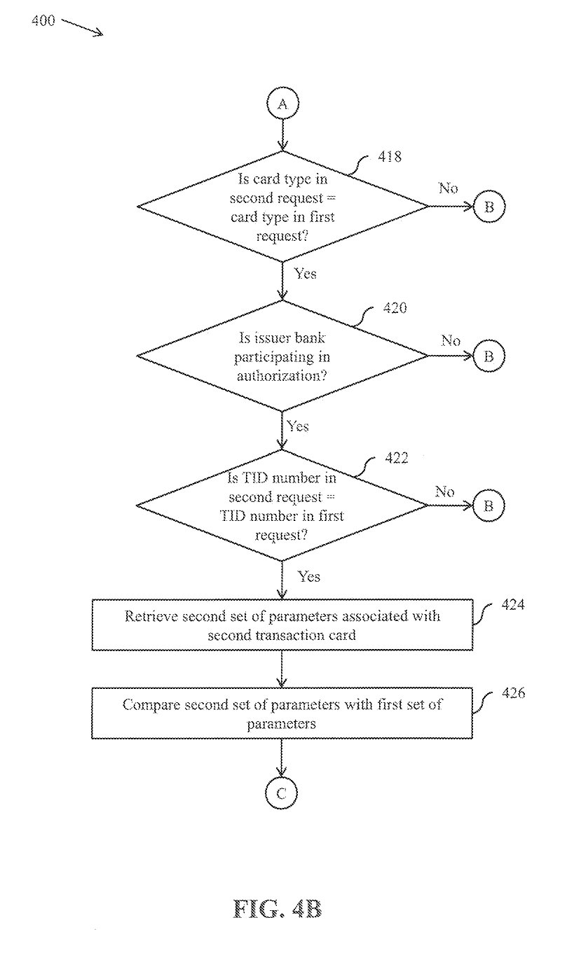

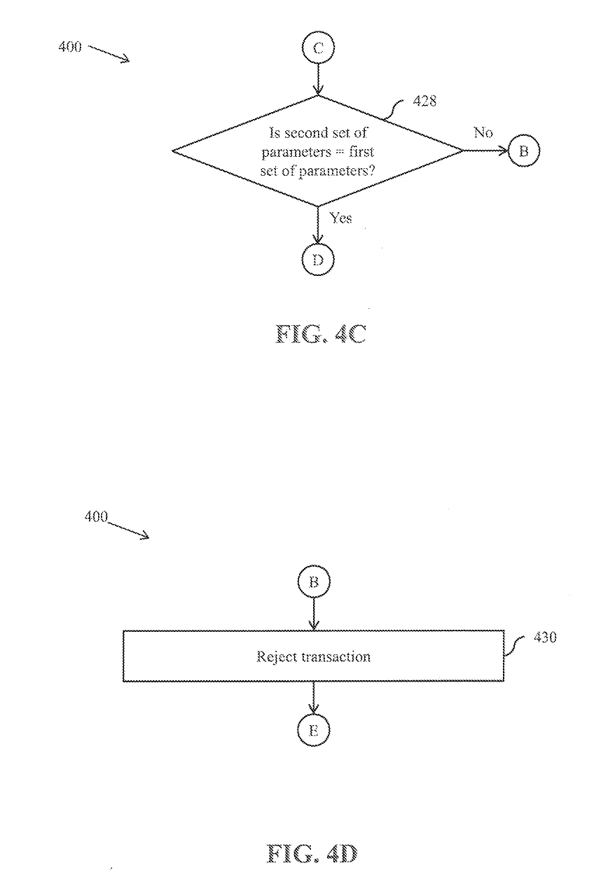

Referring now to FIGS. 4A-4D, a flow chart 400 that illustrates a method for authorizing a transaction implemented using the communication environment 100 of FIG. 1, in accordance with an embodiment of the present disclosure is shown. The user 102 uses the first transaction card 106A at the terminal device 108 to initiate a transaction at a first time instance. At step 402, the authorization management processor 202 receives the first request to initiate authorization, i.e., pre-authorization, for the transaction from one of the terminal device 108, the merchant server 110, and the acquirer server 112. The authorization management processor 202 sets the status of pre-authorization flag to “1” for the transaction based on the first request.

At step 404, the authorization management processor 202 retrieves the first set of parameters associated with the first transaction card 106A from the first issuer server 116A associated with the first transaction card 106A. At step 406, the authorization management processor 202 stores the first set of parameters and the transaction details, such as the card number of the first transaction card 106A, the TID number of the terminal device 108, and the RRN of the transaction, in the memory 204. The authorization management processor 202 links the first set of parameters with the RRN number of the transaction. The authorization management processor 202 reserves an amount associated with the transaction from an “open-to-buy” account balance or credit line of the first account. The user 102 may use the first or second transaction card 106A or 106B at the terminal device 108 to complete the transaction at a second time instance. At step 408, the authorization management processor 202 receives the second request to complete the authorization, i.e., the pre-authorization, for the transaction from one of the terminal device 108, the merchant server 110, and the acquirer server 112. The authorization management processor 202 links the second request to the first request, based on the RRN in the second request and the status of pre-authorization flag “1”.

At step 410, the authorization management processor 202 determines whether the user 102 has used the first transaction card 106A to complete the transaction by comparing the card number of the second request with the card number of the first request. If at step 410, it is determined that the card number of the second request is same as the card number of the first request, i.e., the user 102 has used the first transaction card 106A to complete the transaction, step 412 is executed.

At step 412, the authorization management processor 202 completes the authorization, i.e., the pre-authorization. At step 414, the authorization management processor 202 authorizes the transaction and transmits the result of the authorization to the first issuer server 116A for further processing of the transaction. In an embodiment, the first issuer server 116A captures the amount associated with the transaction from the first account linked to the first transaction card 106A. In another embodiment, the second issuer server 116B captures the amount associated with the transaction from the second account linked to the second transaction card 106B. At step 416, the authorization management processor 202 transmits the authorization response message to the terminal device 108, the merchant server 110, and/or the acquirer server 112. The authorization response message may include an outcome of authorization completion.

If at step 410, it is determined that the card number of the second request is different from the card number of the first request, i.e., the user 102 has used the second transaction card 106B to complete the transaction, step 418 is executed. At step 418, the authorization management processor 202 determines whether the card type in the second request is same as the card type in the first request, i.e., whether the first and second transaction cards 106A and 106B are associated with the same payment network. The authorization management processor 202 compares the card type of the second request with the card type of the first request. If at step 418, it is determined that the card type of the second request is same as the card type of the first request, step 420 is executed.

At step 420, the authorization management processor 202 determines whether an issuer bank, i.e., the second issuer bank, associated with the second transaction card 106B is participating in the authorization, i.e., the pre-authorization. If at step 420, it is determined that the second issuer bank is participating in the authorization, i.e., the pre-authorization, step 422 is executed. At step 422, the authorization management processor 202 determines whether the TID number in the second request is same as the TID number in the first request, i.e., the user 102 has used the first and second transaction cards 106A and 106B at the terminal device 108 to initiate and complete the transaction. If at step 422, it is determined that the TID number of the second request is same as the TID number of the first request, step 424 is executed.

At step 424, the authorization management processor 202 retrieves the second set of parameters associated with the second transaction card 106B from the second issuer server 116B. The second set of parameters includes the permanent account number, the name, or the date-of-birth, the registered contact number, and the address, and the like, of the cardholder of the second transaction card 106B. At step 426, the authorization management processor 202 compares the second set of parameters with the first set of parameters. At step 428, the authorization management processor 202 determines whether the second set of parameters matches the first set of parameters based on the comparison. If at step 428, it is determined that the second set of parameters matches the first set of parameters, step 412 is executed.

If at step 418, it is determined that the card type of the second request is different from the card type of the first request, step 430 is executed. At step 430, the authorization management processor 202 rejects the transaction and does not complete the authorization, i.e., the pre-authorization, and executes step 416. The authorization management processor 202 transmits an instruction for the user 102 to use the first transaction card 106A for completing the authorization or a third card that has same card type as of the first transaction card 106A.

If at step 320, it is determined that the issuer bank, i.e., the second issuer bank, associated with the second transaction card is not participating in the authorization, i.e., the pre-authorization, steps 430 and 416 are executed. It will be apparent to a person skilled in the art that the authorization management processor 202 may also transmit a request to the second issuer server 116B to invoke participation in the authorization.

If at step 422, it is determined that the TID number of the second request is different from the TID number of the first request, step 430 and 416 are executed. The authorization management processor 202 transmits an instruction for the user 102 to use the first transaction card 106A for completing the authorization or a third card that has same card type as of the first transaction card 106A at the terminal device 108.

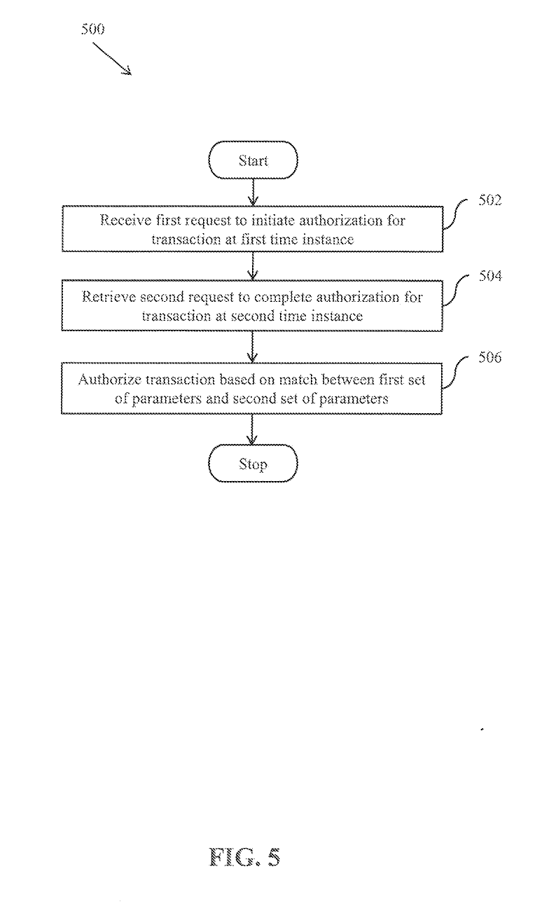

Referring now to FIG. 5, a high-level flow chart 500 that illustrates a method for authorizing a transaction implemented using the communication environment 100 of FIG. 1, in accordance with an embodiment of the present disclosure is shown. The user 102 uses the first transaction card 106A at the terminal device 108 to initiate a transaction at a first time instance. The first set of parameters is associated with the first transaction card 106A. At step 502, a first server, i.e., the payment network server 114, receives the first request to initiate authorization, i.e., pre-authorization, for the transaction from a second server, i.e., the acquirer server 112, at the first time instance.

The user 102 uses the second transaction card 106B at the terminal device 108 to complete the transaction at a second time instance. The second set of parameters is associated with the second transaction card. At step 504, the first server, i.e., the payment network server 114, receives the second request to complete the authorization, i.e., pre-authorization, for the transaction from the second server, i.e., the acquirer server 112, at the second time instance. 106A. At step 506, the first server, i.e., the payment network server 114, authorizes the transaction based on a match between the first set of parameters and the second set of parameters.

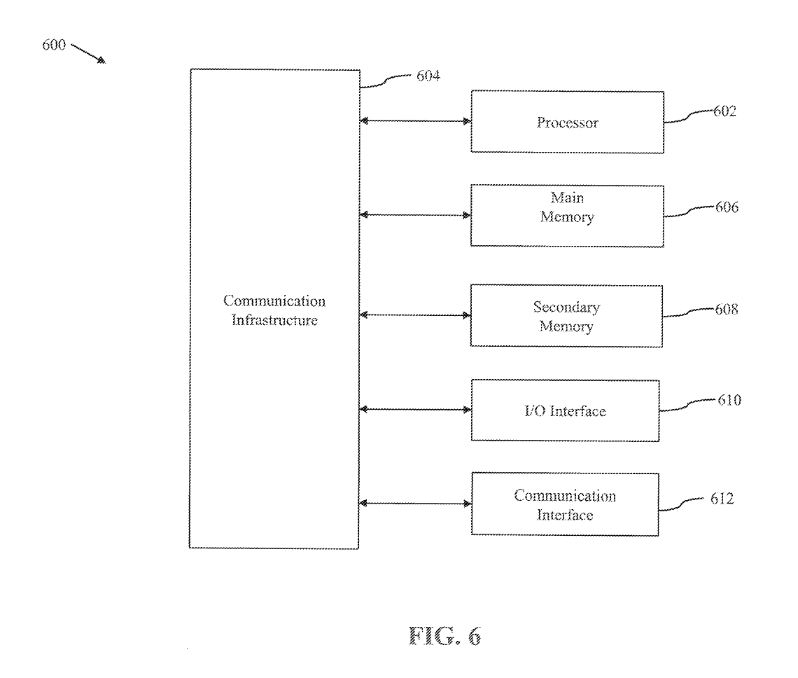

Referring now to FIG. 6, a block diagram that illustrates system architecture of a computer system 600, in accordance with an embodiment of the present disclosure is shown. An embodiment of present disclosure, or portions thereof, may be implemented as computer readable code on the computer system 600. In one example, the user device 104, the terminal device 108, the merchant server 110, the acquirer server 112, the payment network server 114, and the first and second issuer servers 116A and 116B of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIGS. 4A-4D.

The computer system 600 includes a processor 602 that may be a special-purpose or a general-purpose processing device. The processor 602 may be a single processor, multiple processors, or combinations thereof. The processor 602 may have one or more processor cores. In one example, the processor 602 is an octa-core processor. In one embodiment, the processor 602 is the authorization management processor 202. Further, the processor 602 may be connected to a communication infrastructure 604, such as a bus, i.e., the bus 210, message queue, multi-core message-passing scheme, and the like. The computer system 600 may further include a main memory 606 and a secondary memory 608. Examples of the main memory 606 may include RAM, ROM, and the like. In one embodiment, the main memory 606 is the memory 204. The secondary memory 608 may include a hard disk drive or a removable storage drive, such as a floppy disk drive, a magnetic tape drive, a compact disc, an optical disk drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 600 further includes an input/output (I/O) interface 610 and a communication interface 612. The I/O interface 610 includes various input and output devices that are configured to communicate with the processor 602. Examples of the input devices may include a keyboard, a mouse, a joystick, a touchscreen, a microphone, and the like. Examples, of the output devices may include a display screen, a speaker, headphones, and the like. The communications interface 612 may be configured to allow data to be transferred between the computer system 600 and various devices that are communicatively coupled to the computer system 600. Examples of the communications interface 612 may include a modem, a network interface, i.e., an Ethernet card, a communications port, and the like. Data transferred via the communications interface 612 may correspond to signals, such as electronic, electromagnetic, optical, or other signals as will be apparent to a person skilled in the art. The signals may travel via a communications channel (not shown) which may be configured to transmit the signals to devices that are communicatively coupled to the computer system 600. Examples of the communications channel may include, but are not limited to, cable, fiber optics, a phone line, a cellular phone link, a radio frequency link, and the like.

Computer program medium and computer usable medium may refer to memories, such as the main memory 606 and the secondary memory 608, which may be a semiconductor memory such as a DRAM. These computer program mediums may provide data that enables the computer system 600 to implement the methods illustrated in FIGS. 4A-4D and FIG. 5. In an embodiment, the present disclosure is implemented using a computer implemented application, the computer implemented application may be stored in a computer program product and loaded into the computer system 600 using the removable storage drive or the hard disc drive in the secondary memory 608, the I/O interface 610, or communications interface 612.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 602 and a memory such as the main memory 606 and the secondary memory 608 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present disclosure provide, among other features, systems and methods for transaction authorization. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

1. A transaction authorization method comprising:
receiving by a first server, a first request from a second server for initiating authorization for a transaction at a first time instance, when a user uses a first transaction card at a terminal device to initiate the transaction, wherein a first set of parameters is associated with the first transaction card;
receiving by the first server, a second request for completing the authorization for the transaction at a second time instance, when the user uses a second transaction card at the terminal device to complete the transaction, wherein a second set of parameters is associated with the second transaction card; and
authorizing by the first server, the transaction, based on a match between the first set of parameters and the second set of parameters.

2. The transaction authorization method according to claim 1, wherein the first set of parameters include at least one of a permanent account number, a name, and a date-of-birth of a cardholder of the first transaction card.

3. The transaction authorization method according to claim 1, wherein the second set of parameters include at least one of a permanent account number, a name, and a date-of-birth of a cardholder of the second transaction card.

4. The transaction authorization method according to claim 1, further comprising reserving by the first server, an amount associated with the transaction from an account that is linked to the first transaction card, when the first server receives the first request for initiating the authorization.

5. The transaction authorization method according to claim 1, further comprising rejecting by the first server, the transaction based on a mismatch between the first set of parameters and the second set of parameters.

6. The transaction authorization method according to claim 1, wherein an amount associated with the transaction is captured from an account that is linked to the second transaction card, when the first server authorizes the transaction.

7. The transaction authorization method according to claim 1, further comprising determining by the first server, whether an issuer associated with the first transaction card is participating in the authorization, wherein the first server initiates the authorization based on the first request, when the issuer is participating in the authorization.

8. The transaction authorization method according to claim 1, further comprising determining by the first server, whether an issuer associated with the second transaction card is participating in the authorization, wherein the first server completes the authorization based on the second request, when the issuer is participating in the authorization.

9. The transaction authorization method according to claim 1, wherein the first request includes at least a type of authorization, a reference retrieval number, a terminal identification number, and an amount associated with the transaction, and a card number and a card type associated with the first transaction card.

10. The transaction authorization method according to claim 1, wherein the second request includes at least a type of authorization, a reference retrieval number, a terminal identification number, and an amount associated with the transaction, and a card number and a card type associated with the second transaction card.

11. A transaction authorization system comprising:
a first server comprising:
a memory configured to store information pertaining to a plurality of transactions;
a processor that communicates with the memory, wherein the processor is configured to:
receive a first request from a second server for initiating the authorization for a transaction of the plurality of transactions at a first time instance, when a user uses a first transaction card at a terminal device to initiate the transaction, wherein a first set of parameters is associated with the first transaction card;
receive a second request for completing the authorization for the transaction at a second time instance, when the user uses a second transaction card at the terminal device to complete the transaction, wherein a second set of parameters is associated with the second transaction card; and
authorize the transaction based on a match between the first set of parameters and the second set of parameters.

12. The transaction authorization system according to claim 11, wherein the first set of parameters include at least one of a permanent account number, a name, and a date-of-birth of a cardholder of the first transaction card.

13. The transaction authorization system according to claim 11, wherein the second set of parameters include at least one of a permanent account number, a name, and a date-of-birth of a cardholder of the second transaction card.

14. The transaction authorization system according to claim 11, wherein the processor is further configured to reserve an amount associated with the transaction from an account that is linked to the first transaction card, when the first server receives the first request for initiating the authorization.

15. The transaction authorization system according to claim 11, wherein the processor is further configured to reject the transaction based on a mismatch between the first set of parameters and the second set of parameters.

16. The transaction authorization system according to claim 11, wherein an amount associated with the transaction is captured from an account that is linked to the second transaction card, when the first server authorizes the transaction.

17. The transaction authorization system according to claim 11, wherein the processor is further configured to determine whether an issuer associated with the first transaction card is participating in the authorization, wherein the first server initiates the authorization based on the first request, when the issuer is participating in the authorization.

18. The transaction authorization system according to claim 11, wherein the processor is further configured to determine whether an issuer associated with the second transaction card is participating in the authorization, wherein the first server completes the authorization based on the second request, when the issuer is participating in the authorization.

19. The transaction authorization system according to claim 11, wherein the first request includes at least a type of authorization, a reference retrieval number, a terminal identification number, and an amount associated with the transaction, and a card number and a card type associated with the first transaction card, and wherein the second request includes at least the type of authorization, the reference retrieval number, the terminal identification number, and the amount associated with the transaction, and a card number and a card type associated with the second transaction card.

20. A transaction authorization system comprising:
a payment network server comprising:
a memory configured to store information pertaining to a plurality of transactions;
an authorization management processor that communicates with the memory, wherein the authorization management processor is configured to:
receive a first request from an acquirer server for initiating pre-authorization for a transaction of the plurality of transactions at a first time instance, when a user uses a first transaction card at a terminal device to initiate the transaction, wherein a first set of parameters is associated with the first transaction card;
receive a second request for completing the pre-authorization for the transaction at a second time instance, when the user uses a second transaction card at the terminal device to complete the transaction, wherein a second set of parameters is associated with the second transaction card; and
authorize the transaction based on a match between the first set of parameters and the second set of parameters.
